(19) United States
(12) Patent Application Publication
(10) Pub. No.: US 2009/0323822 A1
(43) Pub. Date: Dec. 31, 2009

(54) SUPPORT FOR BLOCKING TRICK MODE OPERATIONS

(76) Inventors: Arturo A. Rodriguez, Norcross, GA (US); Benjamin M. Cook, Flowery Branch, GA (US)

Correspondence Address: MERCHANT & GOULD;SCIENTIFIC ATLANTA, A CISCO COMPANY, P.O. BOX 2903, MINNEAPOLIS, MN, 55402-0903, US

(21) Appl. No.: 12/492,117

(22) Filed: Jun. 25, 2009

Related U.S. Application Data
(60) Provisional application No. 61/075,471, filed on Jun. 25, 2008.
(60) Provisional application No. 61/079,173, filed on Jul. 9, 2008.

(51) Int. Cl. H04N 7/26

(52) U.S. Cl. 375/240.25; 375/E07.027

(57) ABSTRACT

In one embodiment, a method that provides information corresponding to information that assists a receiver provide trick mode operations, such information provided with a corresponding picture, and such information provided in the transport packet containing the start of the corresponding picture, and such information including a tier number corresponding to the picture that conveys picture interdependencies.

### CROSS-REFERENCE TO RELATED APPLICATIONS

This application claims priority to copending U.S. provisional applications entitled, “PVR Assist Systems and Methods,” having Ser. No. 61/075,471, filed Jun. 25, 2008, and “Assist Information for Stream Manipulation,” having Ser. No. 61/079,173, filed Jul. 9, 2008, both of which are entirely incorporated herein by reference.

### TECHNICAL FIELD

The present disclosure relates generally to processing of video streams.

### BACKGROUND

The implementation of digital video with an advanced video compression method is expected to extend the same level of usability and functionality that established compression methods extend to applications and network systems. Video processing devices throughout the network systems should continue to be provisioned with existing levels of video stream manipulation capabilities or better.

When providing video stream manipulation functionality for video streams compressed and formatted in accordance with the Advanced Video Coding (AVC) standard, referred to herein as AVC streams, it becomes difficult to determine whether the video stream is suitable for a particular stream manipulation operation or for operations extending end user functionality such as different video playback modes. Likewise, it becomes difficult for video processing equipment located at any of several locations throughout a network system to fulfill manipulation operations on AVC streams. This is because the AVC standard generally has a rich set of compression tools and can exploit temporal redundancies among pictures in more elaborate and comprehensive ways than prior video coding standards.

### BRIEF DESCRIPTION OF THE FIGURES

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a high-level block diagram depicting an example environment in which an embodiment of systems and methods that implement processing of compressed video and information identifying pictures in respective picture interdependency tiers.

FIG. 2 is a block diagram of an embodiment of a digital home communication terminal (DHCT) as depicted in FIG. 1 and related equipment, in which an embodiment of systems and methods that implement at least in part processing of compressed video and information identifying pictures in respective picture interdependency tiers.

FIG. 3 is a block diagram that illustrates a hierarchy of picture interdependency tiers.

FIG. 4 is a schematic diagram that illustrates an example GOP where every other picture may be signalled with Tiers 1 through 4.

FIG. 5 is a schematic diagram that illustrates an example implementation where a 2× trick mode may be rendered by decoding every other picture.

### DESCRIPTION OF EXAMPLE EMBODIMENTS

### Overview

In one embodiment, a method that provides information corresponding to information that assists a receiver provide trick mode operations, such information provided with a corresponding picture, and such information provided in the transport packet containing the start of the corresponding picture, and such information including a tier number corresponding to the picture that conveys picture interdependencies.

### Example Embodiments

Certain embodiments are disclosed herein that provide, receive, and/or process information (referred to herein also as PVR assistive information) conveyed in a transport stream (e.g., the transport stream compliant to MPEG-2) that assists in, among other operations, personal video recording (PVR) operations and decoded picture buffer management. In particular, system and method embodiments are disclosed that provide, receive, and or process information residing at the transport level in a data field. The information pertains to picture interdependency tiers, memory management control operations (MMCO), and/or other information (e.g., picture information). Further, it should be appreciated that any discussion of data field is not limited to any particular size. Also, flags or subfields are used in the disclosure as partitions of the data field to which respective information may be signaled.

Throughput this specification, tiers should be understood to refer to picture interdependency tiers. Interdependency tiers provide a mechanism to identify sub-sequences that can be decoded (or extracted) independently of other pictures (e.g., starting from an SRAP). Such picture interdependencies may be conveyed by a respective tier level or layer (e.g., designated as a tier number). For instance, in one scheme, a tier-one (Tier 1 or T₁) level or layer or number consists of pictures that are decodable independent of pictures in Tiers 2 through T. Similarly, a tier-two (Tier 2 or T2) level or layer or number consists of pictures that are decodable independent of pictures in Tiers 3 through T, and so on. From another perspective, a Tier T picture may be viewed as pictures that are discardable without affecting the decodability of pictures in Tiers 1 through T-1. Similarly, a Tier (T-1) level or layer or number consists of pictures that are discardable without affecting the decodability of pictures in Tiers 1 through (T-2), and so on. Further explanation of interdependency tiers and/or the signalling of the same may be found in commonly-assigned U.S. Patent Application Publication No. 20080260045, entitled, “Signalling and Extraction in Compressed Video of Pictures Belonging to Interdependency Tiers.”

A hierarchy of data dependency tiers contains “T” tiers. The tiers are numbered with non-negative integers. A tier having a larger tier number is a higher tier than a tier having a smaller tier number. The tiers are ordered hierarchically based on their “decodability” so that any picture in a tier shall:
1. not depend or be predicted directly or indirectly from any picture on any higher tier, and
2. not depend directly or indirectly from processing a picture on any higher tier that affects its prediction from other reference pictures.
   In other words, any picture in Tier K must not depend directly or indirectly on the processing or decoding of any picture in Tier (K+1) or above. Each picture in the AVC stream can conceptually belong to one of T tiers. However, it is not necessary to signal the tier for some pictures. For PVR applications, eight tiers are ample to signal pictures belonging to successive top tiers (i.e, ascending numbered tiers from Tier 1), and pictures belonging to successive bottom tiers (i.e, descending numbered tiers from the highest numbered tier.

Tier 1 consists of the first level of picture extractability, and each subsequent tier corresponds to the next level of picture extractability in the video stream. The highest numbered tier contains discardable pictures. Tier 1 picture can be decoded progressively from a RAP and output independently of all other pictures in the AVC stream. Tier 2 pictures are pictures that can decoded progressively from a RAP and output independently of pictures in Tier 3 through the highest number tier. More generally, for any value of K=1, 2, . . . highest-number tier, a Tier K picture is decodable if all immediately-preceding tier 1 through Tier K pictures in the AVC stream have been decoded progressively from the RAP.

By definition:
1. A picture that depends on a reference picture cannot have a tier number smaller than the tier number of the reference picture.
2. A picture that depends on a picture issuing an MMCO that affects its referencing cannot have a tier number smaller than the tier number of the picture issuing the MMCO.
   Note that a picture issuing an MMCO affecting the order of reference pictures may not need to be decoded but its slice layer processed. PVR Assistive Information is provided in adaptation field of the transport packet that contains in the first byte of its payload the first byte of the associated Access Unit. Note that this transport packet is signaled by the payload unit start indicator. One access unit is provided per PES packet. An extracted sub-sequence of pictures corresponding to a tier is not constrained to be a compliant AVC stream since constraining every extractable sub-sequence of pictures to be a compliant AVC stream indirectly impacts coding performance.

In addition, a description of the MPEG-2 Video Coding standard can be found in the following publication: (1) ISO/IEC 13818-2, (2000), “Information Technology—Generic coding of moving pictures and associated audio—Video.” A description of the AVC video coding standard can be found in the following publication: (2) ITU-T Rec. H.264 (2005), “Advanced video coding for generic audiovisual services.” A description of MPEG-2 Systems for transporting AVC video streams in MPEG-2 Transport packets can be found in the following publications: (3) ISO/IEC 13818-1, (2000), “Information Technology—Generic coding of moving pictures and associated audio—Part 1: Systems,” and (4) ITU-T Rec. H.222.0|ISO/IEC 13818-1:2000/AMD.3, (2004), “Transport of AVC video data over ITU-T Rec. H222.0|ISO/IEC 13818-1 streams.”

In one embodiment, PVR assistive information corresponding to a picture is provided in the adaptation field of an MPEG-2 transport packet to signal the tier number associated with the picture that has its PES (packetized elementary stream) header starting in the first byte of that MPEG-2 trasnport packet's payload.

In some embodiments, in addition to (or in lieu of in some embodiments) the PVR assistive information corresponding to a picture, information pertaining to MMCO is provided in the adaptation field of the same MPEG-2 transport packet. That is, the data field includes PVR assistive information that asserts if an MMCO command is issued with the corresponding picture. In accordance with the AVC (H.264) specification, when decoding a first picture that issues an MMCO command, the reference pictures in the Decoded Picture Buffer (DPB) are affected. Consequently, the referencing of reference pictures that are subsequent to the first picture in the video stream is correct in accordance with the AVC specification. For instance, reference pictures in the DPB are kept rather than allow the sliding window bumping process to remove them from the DPB. Consequently, if the first picture is bypassed during a trick mode operation (i.e., a playback speed or mode other than the normal playback mode), the referencing of reference pictures in the decompression and reconstruction of a second picture after the first picture would be affected. Thus, to enable trick mode operation support the tier numbering is such that (1) a picture that depends on a reference picture cannot have a lower (e.g., smaller) number tier than the reference picture, and (2) a picture that depends on a picture issuing an MMCO command that affects its referencing cannot have a lower number tier than the picture issuing the MMCO command. Otherwise, the picture is not considered extractable and decodable (e.g., for a trick mode operation). Further, a picture issuing an MMCO command affecting references may be processed at the slice level, yet not decoded, e.g., during a trick mode operation as explained further below.

In some embodiments, the data field includes information that identifies a subsequent picture belonging to the same tier number as the picture to which the data field information is associated or indicates that no such identification is present. In one embodiment, the identification may embody a number of pictures away from the current picture.

In some embodiments, a data field may be configured according to two or more of the embodiments described above. Further, some embodiments may signal information that is additive to, or in lieu of, the information expressed above, including whether the corresponding picture is a forward predicted picture. For instance, in one embodiment, information may be provided (e.g., as an extra byte at an SRAP) that conveys the minimum number of independently decodable pictures per a defined time period (e.g., per second), irrespective of a given trick mode (e.g., playback) speed.

It is noted that “picture” is used throughout this specification to refer to an image portion or complete image from a sequence of pictures that constitutes video, or digital video, in one of a plurality of forms. Throughout this specification, video programs or other references to visual content should be understood to include television programs, movies, or any other signals that convey or define visual content such as, for example, those provided by a personal video camera. Such video programs, when transferred, may include compressed data streams corresponding to an ensemble of one or more sequence of pictures and other elements that include video, audio, and/or other data, multiplexed and packetized into a transport stream, such as, for example, a transport stream compliant to MPEG-2 Transport. Although operations are described herein with respect to a “picture,” any other collection of data may be similarly used such a group of pictures, a block, macroblock, slice or other picture portion, etc.

A video stream may further refer to the compressed digital visual data corresponding to any video service or digital video application, including but not limited to, a video program, a video conferencing or video telephony session, any digital video application in which a video stream is transmitted or received through a communication channel in a network system, or any digital video application in which a video stream is stored in or retrieved from a storage device or memory device.

The disclosed embodiments may be embodied in many different forms and should not be construed as limited to the embodiments set forth herein; rather, these embodiments are provided so that this disclosure will be thorough and complete, and will fully convey the scope of the disclosure to those having ordinary skill in the art.

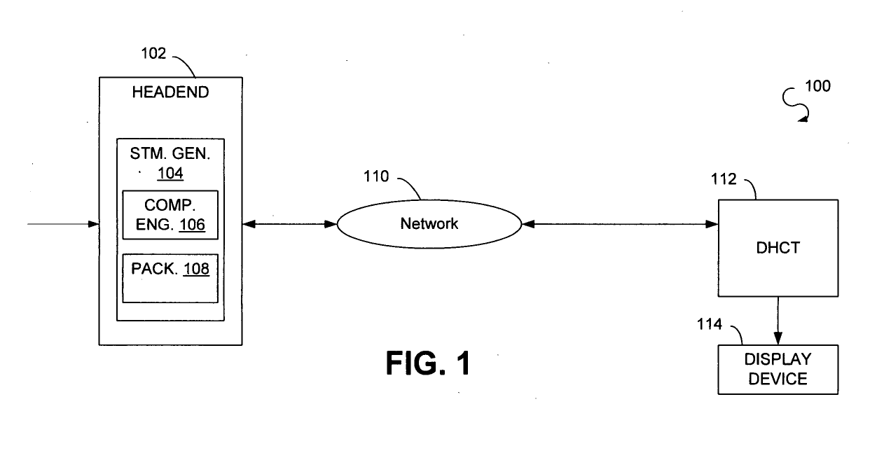

FIG. 1 is a high-level block diagram depicting an example environment in which an embodiment of systems and methods that implement processing of compressed video and information identifying pictures in respective picture interdependency tiers. In particular, FIG. 1 is a block diagram that depicts an example subscriber television system (STS) 100. In this example, the STS 100 includes a headend 102 and one or more digital home communication terminals (DHCTs), such as DHCT 112, that are coupled via a network 110. In one embodiment, the headend 102 includes a transport stream generator 104. The transport stream generator 104 comprises a compression engine 106 and a packetizer 108, which are collectively configured to generate a portion of a transport stream containing a video stream, such as an AVC stream, and PVR assistive information.

In some embodiments, the generation of the transport stream may occur upstream (or downstream, e.g., at a node) of the headend 102. In some embodiments, PVR assistive information may be generated at the DHCT 112, both provided in a transport stream. In some embodiments, both are provided in a program stream. In still some embodiments, transport streams may be generated at the headend 102 and the DHCT 112.

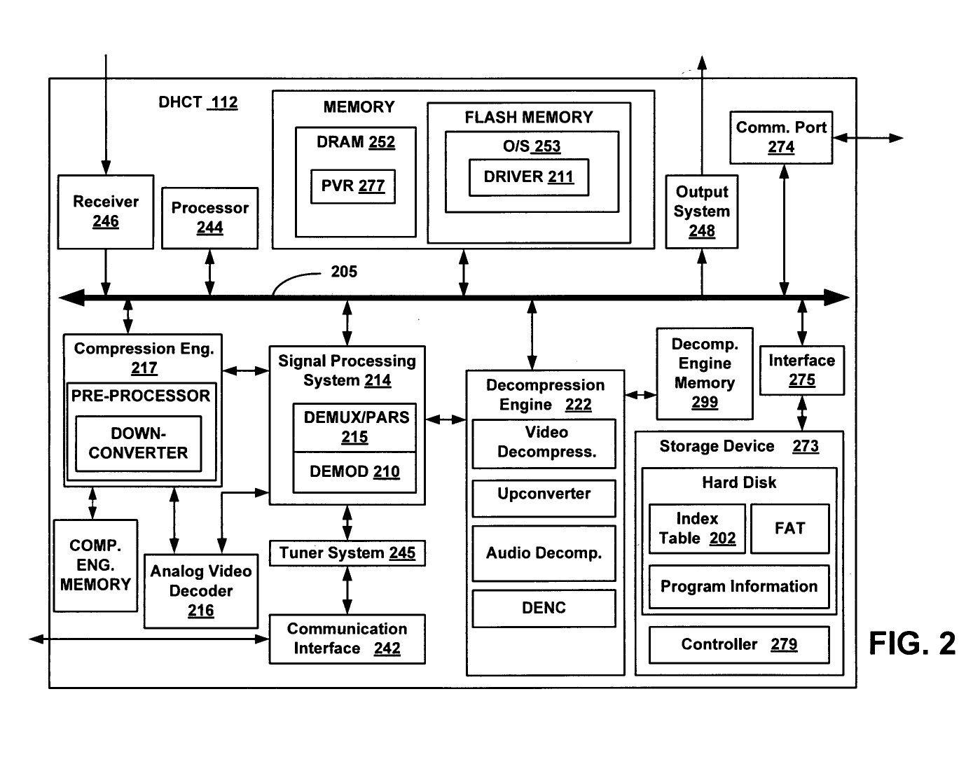

The compression engine 106 (the description of which may also apply in some embodiments to the compression engine 217 of FIG. 2, among others) receives as input a video signal 116, such as a digitized uncompressed video signal or a decompressed video signal. The compression engine 106 outputs a compressed video stream, such as an AVC video stream, and/or other data (e.g., PVR assistive information), wherein compressed pictures of the compressed video stream are provided in the video stream in transmission order. Packetizer 108 packetizes the AVC video stream to output a stream of packets.

The headend 102 and the DHCT 112 cooperate to provide a user with television services including, for example, broadcast video programs, an interactive program guide (IPG), and/or video-on-demand (VOD) presentations, among others. The television services are presented via the display device 114, which is typically a television set that, according to its type, is driven with an interlaced scan video signal or a progressive scan video signal. However, the display device 140 may also be any other device capable of displaying video images including, for example, a computer monitor. Although shown communicating with a display device 140, the DHCT 112 may communicate with other devices that receive, store, and/or process video streams from the DHCT 112, or that provide or transmit video streams or uncompressed video signals to the DHCT 112.

The network 130 may include any suitable medium for communicating video and television service data including, for example, a cable television network or a satellite television network, among others. The headend 102 may include one or more server devices (not shown) for providing video, audio, and other types of media or data to client devices such as, for example, the DHCT 112.

The DHCT 112 is typically situated at a user's residence or place of business and may be a stand-alone unit or integrated into another device such as, for example, a display device 140 or a personal computer (not shown), among other devices. The DHCT 112 receives signals (video, audio and/or other data) including, for example, digital video signals in a compressed representation of a digitized video signal such as, for example, AVC streams modulated on a carrier signal, and/or analog information modulated on a carrier signal, among others, from the headend 102 through the network 130, and provides reverse information to the headend 102 through the network 130.

Although a DHCT is used as an example device throughout the specification, particular embodiments described herein extend to other types of receivers with capabilities to receive and process AVC streams. For instance, particular embodiments are applicable to hand-held receivers and/or mobile receivers that are coupled to a network system via a communication channel. Certain embodiments described herein also extend to network devices (e.g., encoders, switches, etc.) having receive and/or transmit functionality, among other functionality. Particular embodiments are also applicable to any video-services-enabled receiver (VSER) and further applicable to electronic devices such as media players with capabilities to process AVC streams, independent of whether these electronic devices are coupled to a network system. Furthermore, all embodiments, illustrations and examples given herein are intended to be non-limiting, and are provided as an example list among other examples contemplated but not shown.

FIG. 2 is a block diagram of an embodiment of a DHCT 112 as depicted in FIG. 1 and related equipment, in which an embodiment of systems and methods that implement at least in part processing of compressed video and PVR assistive information. It should be understood that the DHCT 112 shown in FIG. 2 is merely illustrative and should not be construed as implying any limitations upon the scope of the disclosure. For example, in some embodiments, the DHCT 112 may have fewer, additional, and/or different components than the components illustrated in FIG. 2. Any of the described subsystems or methods of DHCT 112 and/or stream generator 104 can comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

The DHCT 112 preferably includes a communications interface 242 for receiving signals (video, audio and/or other data) from the headend 102 (FIG. 1) through the network 130 (FIG. 1), and provides reverse information to the headend 102.

The DHCT 112 may further include one or more processors (one processor 244 is shown) for controlling operations of the DHCT 112, an output system 248 for driving the television display 140 (FIG. 1), and a tuner system 245 for tuning to a particular television channel and/or frequency and for sending and receiving various types of data to/from the headend 102 (FIG. 1). The DHCT 112 may include, in some embodiments, multiple tuners for receiving downloaded (or transmitted) data. The tuner system 245 can select from a plurality of transmission signals provided by the subscriber television system 100 (FIG. 1). The tuner system 245 enables the DHCT 112 to tune to downstream media and data transmissions, thereby allowing a user to receive digital media content via the subscriber television system 100. In one embodiment, analog TV signals can be received via tuner system 245. The tuner system 245 includes, in one implementation, an out-of-band tuner for bi-directional data communication and one or more tuners (in-band) for receiving television signals. Additionally, a receiver 246 receives externally-generated user inputs or commands from an input device such as, for example, a remote control device (not shown).

The DHCT 112 may include one or more wireless or wired interfaces, also called communication ports or interfaces 274, for receiving and/or transmitting data or video streams to other devices. For instance, the DHCT 112 may feature USB (Universal Serial Bus), Ethernet, IEEE-1394, serial, and/or parallel ports, etc. The DHCT 112 may be connected to a home network or local network via communication interface 274. The DHCT 112 may also include an analog video input port for receiving analog video signals. User input may be provided via an input device such as, for example, a hand-held remote control device or a keyboard.

The DHCT 112 includes at least one storage device 273 for storing video streams received by the DHCT 112. A PVR application 277, in cooperation with operating system 253 and device driver 211, effects among other functions, read and/or write operations to/from the storage device 273. The processor 244 may provide and/or assist in control and program execution for operating system 253, device driver 211, applications (e.g., PVR 277), and data input and output. The processor 244 may further provide and/or assist in receiving and processing PVR assistive information, identifying and extracting of pictures belonging respectively to one or more tiers, identifying and discarding of pictures belonging respectively to one or more tiers, and decoding and outputting a video stream after the extraction or discarding of identified pictures. The processor 244 may further assist or provide PVR assistive information for a received compressed video stream or compressed video stream produced by DHCT 112. Herein, references to write and/or read operations to the storage device 273 can be understood to include operations to the medium or media of the storage device 273. The device driver 211 is generally a software module interfaced with and/or residing in the operating system 253. The device driver 211, under management of the operating system 253, communicates with the storage device controller 279 to provide the operating instructions for the storage device 273. As conventional device drivers and device controllers are well known to those of ordinary skill in the art, further discussion of the detailed working of each will not be described further here.

The storage device 273 may be located internal to the DHCT 112 and coupled to a common bus 205 through a communication interface 275. The communication interface 275 may include an integrated drive electronics (IDE), small computer system interface (SCSI), IEEE-1394 or universal serial bus (USB), among others. Alternatively or additionally, the storage device 273 may be externally connected to the DHCT 112 via a communication port 274. The communication port 274 may be according to the specification, for example, of IEEE-1394, USB, SCSI, or IDE. In one implementation, video streams are received in the DHCT 112 via communications interface 242 and stored in a temporary memory cache (not shown). The temporary memory cache may be a designated section of DRAM 252 or an independent memory attached directly, or as part of a component in the DHCT 112. The temporary cache is implemented and managed to enable media content transfers to the storage device 273. In some implementations, the fast access time and high data transfer rate characteristics of the storage device 273 enable media content to be read from the temporary cache and written to the storage device 273 in a sufficiently fast manner. Multiple simultaneous data transfer operations may be implemented so that while data is being transferred from the temporary cache to the storage device 273, additional data may be received and stored in the temporary cache.

The DHCT 112 includes a signal processing system 214, which comprises a demodulating system 210 and a transport demultiplexing and parsing system 215 (herein demultiplexing system) for processing broadcast and/or on-demand media content and/or data. One or more of the components of the signal processing system 214 can be implemented with software, a combination of software and hardware, or in hardware. The demodulating system 210 comprises functionality for demodulating analog or digital transmission signals.

An encoder or compression engine, as explained above in association with FIG. 1, may reside at the headend 110 (e.g., embodied as compression engine 106), in the DHCT 112 (e.g., embodied as compression engine 217), or elsewhere. The compression engine 217 can receive a digitized uncompressed video signal, such as, for example, one provided by analog video decoder 216, or a decompressed video signal produced by a decompression engine (e.g., decompression engine 222) as a result of decompressing a compressed video signal. In one embodiment, digitized pictures and respective audio output by the analog video decoder 216 are presented at the input of the compression engine 217, which compresses the uncompressed sequence of digitized pictures according to the syntax and semantics of a video compression specification. Thus, the compression engine 217 implements a video compression method or algorithm that corresponds to a respective video compression specification, such as the AVC standard, to provide a video stream. The compression engine 217 may further provide PVR assistive information for the provided video stream.

The systems and methods disclosed herein are applicable to any video compression method performed according to a video compression specification allowing for at least one type of compressed picture that can depend on the corresponding decompressed version of each of more than one reference picture for its decompression and reconstruction. For example, the compression engine 217 (or 106) may compress the input video according to the specification of the AVC standard and produce an AVC stream containing different types of compressed pictures, some that may have a first compressed portion that depends on a first reference picture for their decompression and reconstruction, and a second compressed portion of the same picture that depends on a second and different reference picture.

In some embodiments, a compression engine with similar compression capabilities, such as one that can produce AVC streams, is connected to the DHCT 112 via communication port 274, for example, as part of a home network. In another embodiment, a compression engine with similar compression capabilities, such as one that can produce AVC streams, may be located at the headend 102 or elsewhere in the network 130. The compression engine in the various embodiments may include capabilities to PVR assistive information for a produced video stream.

Unless otherwise specified, a compression engine as used herein may reside at the headend 102 (e.g., as compression engine 106), in the DHCT 112 (e.g., as compression engine 217), connected to DHCT 112 via communication port 274, or elsewhere. Likewise, video processing devices as used herein may reside at the headend 102, in the DHCT 112, connected to the DHCT 112 via communication port 274, or elsewhere. In one embodiment, the compression engine and video processing device reside at the same location. In another embodiment, they reside at different locations. In yet another embodiment, the compression engine and video processing device are the same device.

The compressed video and audio streams are produced in accordance with the syntax and semantics of a designated audio and video coding method, such as, for example, MPEG-2 or AVC, so that the compressed video and audio streams can be interpreted by the decompression engine 222 for decompression and reconstruction at a future time. Each AVC stream is packetized into transport packets according to the syntax and semantics of transport specification, such as, for example, MPEG-2 transport defined in MPEG-2 systems. Each transport packet contains a header with a unique packet identification code, or PID, associated with the respective AVC stream.

The demultiplexing system 215 can include MPEG-2 transport demultiplexing capabilities. When tuned to carrier frequencies carrying a digital transmission signal, the demultiplexing system 215 enables the separation of packets of data, corresponding to the desired AVC stream, for further processing. Concurrently, the demultiplexing system 215 precludes further processing of packets in the multiplexed transport stream that are irrelevant or not desired, such as packets of data corresponding to other video streams. Parsing capabilities of the demultiplexing system 215 allow for the ingesting by the DHCT 112 of program associated information carried in the transport packets. Parsing capabilities of the demultiplexing system 215 may allow for ingesting by DHCT 112 of PVR assistive information (including information that assists in trick play operations).

In one embodiment, PVR assistive information can be provided by specifying explicit information in the private data section of the adaptation field or other fields of a transport stream packet, such as that of MPEG-2 transport. In one embodiment, the signaling and provision of such information is at the video program's multiplex level, or the transport layer (rather than in the video layer—in other words, in the non-video coding layer). The PVR assistive information can be carried as unencrypted data via, for example, private data carried in the adaptation field of MPEG-2 Transport packets.

For instance, a transport packet structure according to MPEG-2 comprises 188 bytes, and includes a 4-byte header with a unique packet identifier, or PID, that identifies the transport packet's corresponding stream. An optional adaptation field may follow the transport packet's header. The payload containing a portion of the corresponding stream follows the adaptation field, if present in the transport packet. If the adaptation field is not present, the payload follows the transport header. The PVR assistive information corresponding to the compressed pictures in the AVC stream are provided, in one embodiment, in the adaptation field and thus not considered as part of the video layer since the adaptation field is not part of transport packet's payload nor part of the AVC specification but rather part of the syntax and semantics of MPEG-2 Transport in accordance with the MPEG-2 systems standard.

The header of a transport stream may include a sync byte that sets the start of a transport stream packet and allows transmission synchronization. The header of the transport stream may further include a payload unit start indicator that, when set to a certain value (e.g., 1b in MPEG-2 Transport) in the packets carrying the video stream, indicates that the transport packet's payload begins with the first byte of a packet of a packetized elementary stream (PES). Video streams carried in a PES may be constrained to carrying one compressed picture per PES packet, and that a PES packet commences as the first byte of a transport streams' packet payload. Thus, the payload unit start indicator provisions the identification of the start of each successive picture of the video stream carried in the transport stream. Note that the transport packets carrying the video stream are identified by the parsing capabilities of DHCT 112 (as described above) from program associated information or program specific information (PSI). For instance, in MPEG-2 Transport, program map tables identify the packet identifier (PID) of the video stream in the program map table (PMT), which in turn is identified via the program association table (PAT).

It should be noted that the PVR assistive information is provided in the transport layer unencrypted and enables a video decoder or other video processing device located in a network to determine for a particular application or operation, such as a trick mode operation, which pictures to extract from the video stream, which pictures to discard from the video stream, the identity of the subsequent picture belonging to the same tier level as the picture associated with the tier information, and/or the minimum number of independently decodable pictures per defined time period, without having to parse the compressed video layer or video stream.

The PVR assistive information identifies pictures in the video stream that belong respectively to one or more picture interdependency tiers. This in turn enables the annotation of the successive location of pictures corresponding to respective picture interdependency tiers, when the video program is stored in a hard-drive of the DHCT 112. The video program may be stored as a transport stream. In an alternate embodiment, it may be stored as a program stream. The annotated locations of pictures of the video program may be processed by processor 244 while executing the PVR application 277 to extract the pictures of the video program belonging to the lowest numbered tier (i.e, Tier 1) from a starting point, or to extract additional pictures belonging to each respective successive tier number from the same starting point (i.e., ascending numbered tiers, as described below) to provide a trick mode operation.

One or more flags in a transport packet header or in the adaptation field may identify starting points or random access points that may serve as starting points for tracking PVR assistive information, such as the minimum number of independently decodable pictures per defined time period. For instance, the adaptation field in MPEG-2 Transport packets includes the random access indicator and the elementary stream priority indicator. Some information may be provided in association with every picture in some embodiments.

The components of the signal processing system 214 are generally capable of QAM demodulation, forward error correction, demultiplexing of MPEG-2 transport streams, and parsing of packets and streams. Stream parsing may include parsing of packetized elementary streams or elementary streams. Packet parsing may include parsing and processing of fields that deliver PVR assistive information corresponding to the AVC stream. In some embodiments, parsing performed by signal processing system 214 extracts the PVR assistive information and processor 244 provides processing and interpretation of the PVR assistive information. In yet another embodiment, processor 244 performs parsing, processing, and interpretation of the PVR assistive information. The signal processing system 214 further communicates with the processor 244 via interrupt and messaging capabilities of the DHCT 112. The processor 244 annotates the location of pictures within the video stream or transport stream as well as other pertinent information corresponding to the video stream. Alternatively or additionally, the annotations may be according to or derived from the assist information corresponding to the video stream. The annotations by the processor 244 enable normal playback as well as other playback modes of the stored instance of the video program. Other playback modes, often referred to as “trick modes,” may comprise backward or reverse playback, forward playback, or pause or still. The playback modes may comprise one or more playback speeds other than the normal playback speed. In some embodiments, the PVR assistive information is provided to the decompression engine 222 by the processor 244. In another embodiment, the annotations stored in the storage device are provided to the decompression engine 222 by the processor 244 during playback of a trick mode. In yet another embodiment, the annotations are only provided during a trick mode, wherein the processor 244 has programmed the decompression engine 222 to perform trick modes.

Annotations may be simply PVR assistive information. Processor 244 can extract pictures from low numbered tiers and/or discard pictures from high numbered tiers as further described below.

The packetized compressed streams can also be outputted by the signal processing system 214 and presented as input to the decompression engine 222 for audio and/or video decompression. The signal processing system 214 may include other components (not shown), including memory, decryptors, samplers, digitizers (e.g., analog-to-digital converters), and multiplexers, among others. The demultiplexing system 215 parses (e.g., reads and interprets) transport packets, and deposits the information corresponding to the PVR assistive information corresponding to the AVC stream into DRAM 252.

Upon effecting the demultiplexing and parsing of the transport stream, the processor 244 interprets the data output by the signal processing system 214 and generates ancillary data in the form of a table or data structure (index table 202) comprising the relative or absolute location of the beginning of certain pictures in the compressed video stream in accordance with the PVR assistive information corresponding to the video stream. The processor 244 also processes the information corresponding to the PVR assistive information to make annotations for PVR operations. The annotations are stored in the storage device by the processor 244. In one embodiment, the PVR assistive information comprises of the annotations and it is stored in the hard drive. Such ancillary data is used to facilitate the retrieval of desired video data during future PVR operations.

The demultiplexing system 215 can parse the received transport stream (or the stream generated by the compression engine 217, which in some embodiments may be a program stream) without disturbing its video stream content and deposit the parsed transport stream (or generated program stream) into the DRAM 252. The processor 244 can generate the annotations even if the video program is encrypted because the PVR assistive information of the AVC stream is carried unencrypted. The processor 244 causes the transport stream in DRAM 252 to be transferred to a storage device 273. Additional relevant security, authorization and/or encryption information may be stored. Alternatively or additionally, the PVR assistive information corresponding to the AVC stream may in the form of a table or data structure comprising the interdependencies among the pictures, as explained further below.

Note that in one embodiment, reference herein to a decoding system comprises decoding functionality and cooperating elements, such as found in the collective functionality of the decompression engine 222, processor 244, signal processing system 214, and memory. In some embodiments, the decoding system can comprise fewer, greater, or different elements. Further, certain system and method embodiments include components from the headend (e.g., the compression engine 106, etc.) and/or components from the DHCT 112, although fewer or greater amount of components may be found in some embodiments.

AVC streams, or other compressed video streams, comprise pictures that may be encoded according to a hierarchy of picture interdependencies, or tiers of picture dependencies. Pictures are associated with hierarchy of tiers based on picture interdependencies. Each compressed picture belongs to at most one tier. Tiers are numbered sequentially starting with tier number 1. Pictures having the lowest tier number do not depend for their decompression and reconstruction on pictures having any higher numbered tier. Thus, PVR assistive information is to be provided consistent identification, such that any identified picture corresponding to a tier is not dependent on pictures belonging to any higher numbered tier. Another aspect of the hierarchy of tiers is that decoding of some pictures depends on particular other pictures. Therefore, if one picture serves as a reference picture to other pictures, it can be considered more important than other pictures. In fact, a particular set of pictures can be viewed in a hierarchy of importance, based on picture interdependencies.

One embodiment of a stream generator 104 selects I and IDR-pictures for inclusion in the lowest numbered tier. Another embodiment also includes forward predicted pictures in the lowest numbered tier. An anchor picture can be an I-picture, IDR-picture, or a FPP (forward predicted picture) that depends only on a past reference pictures. In some embodiments, an FPP is an anchor picture if it only depends on the most-recently decoded anchor picture.

Pictures can be categorized as belonging a particular picture interdependency tier or “level” or number, and some embodiments of a stream generator may include PVR assistive information for tiers above a certain tier of the hierarchy (e.g., the two lowest numbered tiers). In another embodiment, PVR assistive information may be provided only for tiers below a particular tier of the hierarchy (e.g., the two highest tier numbers). In yet another embodiment, PVR assistive information may be provided only for high numbered tiers, for low numbered tiers a, or for a combination of both low numbered tiers and high numbered tiers. PVR assistive information may be provided starting from the tier 1, and/or starting from the highest number tier. A picture's corresponding tier may be understood as a measure of its importance in decoding other pictures—some reference pictures are more important than other reference pictures because their decoded and reconstructed information propagates through more than one level of referencing.

A person of ordinary skill in the art should also recognize that although AVC picture types are used in this disclosure, the systems and methods disclosed herein are applicable to any digital video stream that compresses one picture with reference to another picture or pictures.

An AVC stream is used as an example throughout this specification. However, particular embodiments are also applicable to any compressed video stream compressed according to a video compression specification allowing for: (1) any picture to be compressed by referencing more than one other picture, and/or (2) any compressed picture that does not deterministically convey or imply its actual picture-interdependency characteristics from its corresponding picture-type information in the video stream.

The transmission order of pictures is different than the output or display order due to the need to have the reference pictures prior to decoding a picture. Note that P pictures can be forward predicted or backwards predicted, and typically, that fact is not evident until the pictures are decoded. For instance, knowledge of the picture type (e.g., as ascertained by a header) does not necessarily convey how prediction is employed or picture interdependencies.

In MPEG-2, discardable pictures can be output immediately (no need to retain), though typically, for implementation reasons, such pictures are temporarily stored for at least a picture period or interval. In AVC streams, even with discardable pictures (i.e, non-reference pictures), there are circumstances where the output of the discardable, decoded picture is delayed and hence retained in the decoded picture buffer (DPB).

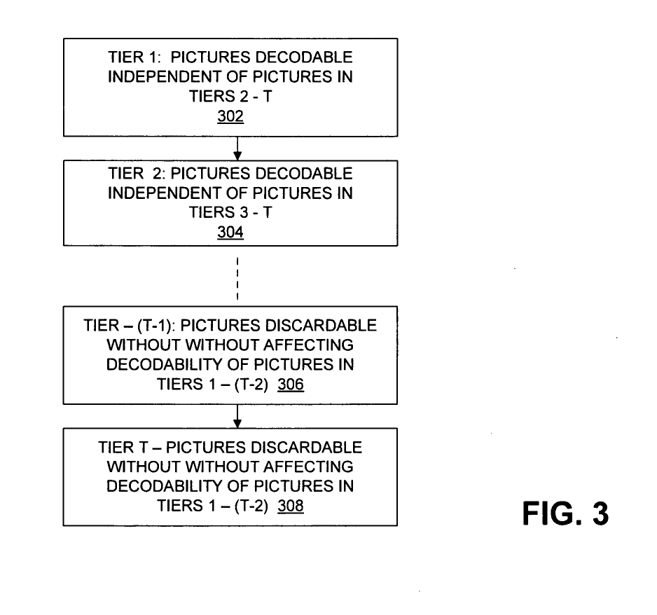

FIG. 3 illustrates an example of the hierarchy of picture interdependency tiers. A hierarchy of picture interdependency tiers has “T” tiers, T being the highest number tier. A picture in a video stream can only belong to one of the T tiers. However, in some embodiments, the stream generator 104 may opt to not identify the pictures belonging to some middle tiers in its provided tier information. Tier 1 302 comprises of pictures in the video stream that can be decoded independently from pictures in Tiers 2 through T. Tier 1 is the first level of picture extraction. Each successive tier can be decoded independently from pictures in the video stream belonging to higher numbered tiers. For instance, the Tier 2 304 can be decoded independently of pictures belonging to tiers 3 through T.

Accordingly, Tier 1 302 pictures comprise those pictures that are decodable independent of pictures in Tier 2 304 through Tier T 308. Tier 2 304 pictures are pictures that are decodable independent of pictures in Tiers 3 through T 308, and so on.

Pictures in Tier T 308, can be discarded without affecting the decodability of pictures remaining in the video streams that correspond to lower numbered tiers. Tier T 308 pictures are those that are discardable without affecting the decodability of pictures in Tiers 1 302 through (T-1) 306. Tier—(T-1) pictures are those that are discardable without affecting the decodability of the pictures remaining in the video stream that have Tiers 1 302 through T-2 (not shown).

Tier 1 302 comprises of coded pictures (e.g., compressed pictures) in the video stream that when extracted progressively from a starting point in the video stream, such as a random access point, can be decoded and output independently of other coded pictures in the video stream. Tier 2 304 comprises of coded pictures in the video stream that when extracted progressively from the same starting point in the video stream, in concert with the progressive extraction with pictures belonging to Tier 1 302, adds another level of picture extraction. Thus, Tier 1 302 and Tier 2 304 can be decoded and output independently of other coded pictures in the video stream, that is, independent of pictures “determined not to belong to” or “not identified” as Tier 1 302 or Tier 2 304 coded pictures. More generally, for any value of K from 1 to T, pictures belonging to Tiers 1 through K are identified or determined to belong to Tiers 1 through K from received or provided assist information at DHCT 112. Thus, if in a progressive manner “all” the pictures belonging to Tiers 1 through K are: (1) extracted from the video stream from a starting point, and (2) decoded, then the next picture in the video stream with a tier number less than or equal to K can be extracted and decoded because all of the pictures that it depends on for temporal prediction and/or for motion compensation or pictures that it references as reference pictures, or pictures that affect its references, will have been: (1) extracted from the video stream, (2) decoded and (3) available to be referenced.

It is noted that throughout this specification reference to a picture belonging to a tier or a picture in a tier is to be understood as a picture signaled with a tier number or a picture corresponding to a tier.

A Tier-K coded picture in the video stream can be extracted and guaranteed to be decoded into its intended complete and full reconstruction if extraction and decoding of all immediately-preceding Tier-K coded pictures has been performed progressively for a finite amount of time prior to the extraction of that particular Tier-K coded picture. This is because video coding may perform temporal references across GOP boundaries. In one embodiment, a Tier-K coded picture can be extracted and decoded in its intended complete and full reconstruction if all coded pictures belonging to tiers Tier 1 through Tier K have been extracted and decoded progressively since or for at least the last “n” Random Access Points (RAPs) in the video stream immediately prior to the particular Tier-K coded picture. For instance, if a playback mode or trick mode, such as a fast forward, is to commence from a particular or desired location of the video stream, if may be necessary to start decoding at the second RAP (i.e., n =2) prior to the particular location of the video stream. RAPs can be signaled and identified with one or more specific flags in the MPEG-2 Transport level or layer's header and/or the adaptation field header. For instance, specifications such as MPEG-2 Systems provisions indicators in the transport stream, such as a random access point indicator and/or an elementary stream priority indicator, that serve to signal a RAP. In one embodiment, the RAP refers to an access unit (or picture) in the AVC bitstream at which a receiver can start the decoding of the video stream. After the RAP, the video stream includes a sequence parameter set (SPS) and a picture parameter set (PPS) used for decoding the associated picture with the RAP (and pictures thereafter), and any other necessary parameters or set of parameters required to decode and output the pictures of the video stream. The random access points may carry an I picture or an IDR picture. In one embodiment, the GOP, typically an MPEG-2 term, is equivalent to the picture sequences and picture interdependencies found between two or more RAPs.

In one embodiment, start codes may be used to identify where a picture begins. For instance, the beginning of a picture in a PES packet may be aligned with the beginning of the payload of a transport packet. Hence, the beginning of a picture can be identified to enable the extraction (for decoding or discarding) of pictures. In some embodiments, information available at the transport level enables the identification of the beginning of pictures. For instance, for MPEG-2 transport stream packets carrying a video stream, the payload unit start indicator, may identify when the transport stream packet payload begins with the first byte of an MPEG-2 PES packet.

In some embodiments, a Tier-K coded picture can be extracted and decoded in its intended complete and full reconstruction if all coded pictures belonging to tiers Tier 1 through Tier K have been extracted and decoded progressively since or for at least the last “n” beginnings of Group of Pictures (GOPs) in the video stream immediately prior to the particular Tier-K coded picture.

Applying tiers to an example implementation, such as PVR, in an MPEG-2 video stream encoded with a common GOP where the pictures in output order are as follows: I B B P B B P B B P B B P and so on, Tier 1 302, may be sufficient. For example, I pictures may be exclusively utilized in fast forward or rewind operations. But suppose that a finer level of granularity is desired for trick modes, or for improved accuracy in placement or removal of a picture in the trick mode operations. A second and/or third tier may be added to allow for this improved functionality while handling the complexities of AVC. Note that depending on the desired trick mode functionality (e.g., speed, direction, etc.), one embodiment may decode pictures belonging to tier 1 (e.g., 15× trick modes). In some embodiments, decoding may be implemented with pictures from the tiers 1 and 2.

Having provided a background on hierarchical tiers and the properties of the pictures belonging to the respective tiers, attention is now directed to a system and method that provides, receives, and/or processes PVR assistive information. A brief background of MMCO functionality is provided as follows. A data field value may result in the corresponding picture issuing an MMCO command, which in some embodiments marks a reference picture as “no longer needed for reference” in accordance to the AVC specification. For instance, a value of “0” (or no value in some embodiments) may indicate that no MMCO command is issued in the corresponding picture. Note that in some embodiments, the need for an MMCO command may not be needed. In other words, the absence of an MMCO command does not cause a reference picture used by a subsequent picture in the video stream to be bumped from the DPB.

An MMCO can only be issued by a reference picture in accordance with the AVC specification. However, a non-reference picture may enter the DPB if it has output time unequal or after to its decode time. In one embodiment, when a non-reference picture is required to enter the DPB. If an MMCO is needed to be issued concurrently with the decoding of the non-reference picture (i.e., in accordance with the AVC specification to mark at least one reference picture in the DPB as a non-reference picture), although not used as a reference picture, the non-reference picture is signaled as a reference picture to enable the picture to issue the MMCO. In this embodiment, PVR assistive information is signaled with the non-reference picture signaled as a reference picture and the PVR assistive information also signals that this picture issues an MMCO.

In some embodiments, other information may be signaled in the transport stream. For instance, in one embodiment, an extra byte may be added (e.g., by stream generator 104) at an SRAP to convey the minimum number of independently decodable pictures per second, irrespective of trick mode speed. For instance, for tiers 1 to K, 3 bits as one example parameter.

In some embodiments, the existence of the PVR assistive information corresponding to a minimum decodable picture may be signaled in the transport stream. In other words, a specific message carries the PVR assistive information. In some embodiments, an “announcement” may be provided that alerts devices or otherwise makes it known that a specific message carrying PVR assistive information is present in the transport stream. For instance, the specific message carrying the PVR assistive information can be announced with a corresponding specific announcement through the ES information loop of the PMT. Such an announcement serves to simply identify that the transport stream contains the specific message that carries PVR assistive information. In one embodiment, the format of the specific message can be via an assigned message identification (e.g., a descriptor tag) and corresponding message length (e.g., a tag length). For instance, a descriptor tag may convey to a decoder that information of a particular type (e.g., corresponding to one of a plurality of tag values) is present in the transport stream

Note that, though the above PVR assistive information is explained in the context of an AVC environment, MPEG-2 video, and in particular, MPEG-2 video GOPs are contemplated to be within the scope of the embodiments disclosed herein.

PVR assistance information is provided in a data field to signal information that helps PVR applications running in a receiver perform trick-play operations. The PVR assistance information may be specific to H.264/AVC compressed video.

PVR assistance information includes a tier number for one or more respective pictures to convey the picture interdependencies in the compressed video stream. Coding of this syntax element is specified in section D.3.3 (from DVB). In addition to a tier number, PVR assistance information provided with a picture may include a syntax element that pertains to blocking of trick modes. Blocking of trick modes may be indicated by flag that signals the presence of information with the assistance information that corresponds blocking of trick modes.

PVR assistance information corresponds to signalling of a tier number in accordance with a Tier framework signals according to the value of the tier corresponding to a picture determines whether that picture is extractable and decodable for certain trick modes. In other words, the tier number conveys not only information about that corresponding picture but its relationship to other pictures in the compressed video stream, such relationship being according to pictures interdependencies for decoding and outputting that picture. This allows the PVR application to efficiently select pictures when performing a given trick-mode.

PVR assistance information for a corresponding picture is provided in the private data field of MPEG-2 transport stream packets containing the packetized elementary stream (PES) header of the PES packet containing the corresponding picture. Each PES packet in the video stream is constrained to contain one AVC picture or access unit (AU). The tier numbering framework achieves independently decodable sub-sequences that can be extracted and used by PVR applications to fulfil trick modes.

A hierarchy of data dependency tiers contains at most 7 tiers. The tiers are ordered with successive positive integeres based on their “decodability” so that any picture with a particular tier number does not depend directly or indirectly on any picture with a higher tier number.

Each picture in the video stream may belong to one the tier numbers such that a picture in the k^{th} tier, where k is an integer, shall not depend directly or indirectly on the processing or decoding of any picture in the (k+1)^{th} tier or above. In other words:

A picture that depends on a reference picture cannot have a tier number smaller than the tier number of the reference picture.

A picture that depends on a picture issuing an MMCO that affects its picture referencing cannot have a tier number smaller than the tier number of the picture issuing the MMCO.

In addition, in the tier framework other parameters such as ‘m_cumulative_frames’ and ‘PVR_assist_tier_m’ are included to signal the minimum number for pictures intended to be extracted and decoded per each 1 second interval for a particular trick mode speed and higher.

The number of pictures signalled from Tiers 1 through n should be approximately half the number of pictures per every consecutive 1.0 second interval of the video stream. A sufficient number of pictures provided to fulfil 2× playback speed is also sufficient for playback speeds higher than 2×

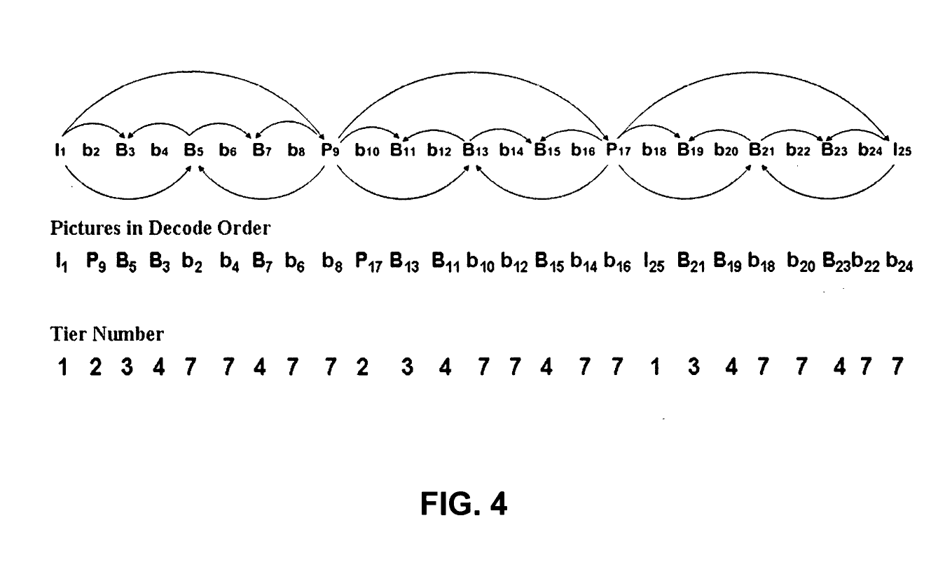

The GOP depicted in FIG. 4 illustrates that every other picture may be signalled with Tiers 1 through 4. The first and second rows depict picture output order and decode order, respectively; the third row shows the respective tier number of each picture in decode order. A wide range of playback speeds are possible from Tier 1 pictures only (i.e., very fast) to higher tier numbers. A PVR application may provide alternate speeds with the pictures in Tiers 1 to (k−1) and a portion of the pictures in tier k.

PVR assistive information is conveyed in the adaptation field of a transport packet that is “associated” with the start of an access unit. The PVR assistive information pertains to the associated access unit.

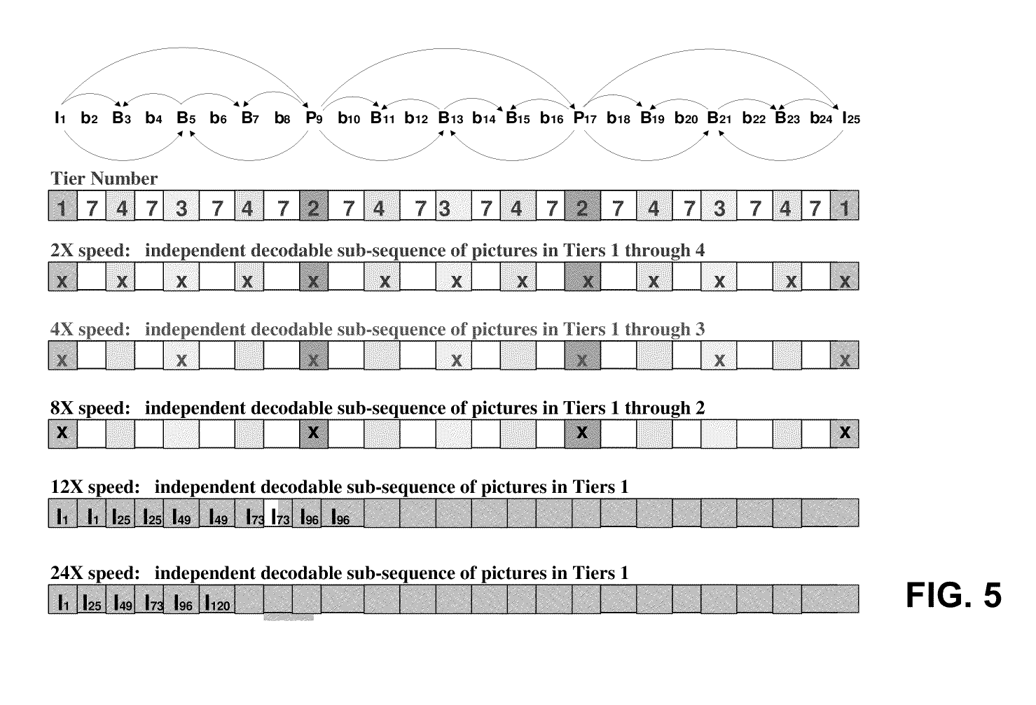

In FIG. 5, 2× trick mode may be rendered by decoding every other picture. In some cases, a PVR application may provide a 2× playback speed by decoding the pictures in tiers 1 to 3 and repeating the output of each picture once.

The tier framework can also be used to signal discardable pictures, or different categories of discardable pictures. For instance, with an MPEG-2 like GOP with three B pictures between reference pictures, the middle B picture of every trio can be signalled as a Tier ‘6’ picture and the other two as Tier ‘7’ pictures. This facilitates retention of the temporal sampling of the video when pictures need to be discarded.

A block trick_mode flag provided with the PVR assistance information corresponding to the picture associated with a Random-access point (RAP) to signal or indicate the presence of information corresponding to the blocking of trick modes. The block trick mode flag signals to the PVR application to disable trick modes until the next RAP.

Another flag (i.e., a second flag) provided with the PVR assistance information signals the presence of information corresponding to the outputting or presentation of the picture corresponding to the PVR assistance information.

Yet another flag (i.e., a third flag) provided with the PVR assistance information corresponding to a picture signals the presence of a data field having a value that identifies the location of the next picture in the compressed video stream (in decode order) that has the same tier number as the tier number of the current picture. When the third flag signals the presence of information, included with PVR assistance information is a field that contains the number of pictures in the video stream away from the current picture where the next picture having the same tier number equal to tier number provided for the current picture.

Yet another flag (i.e., a fourth flag) provided with the PVR assistance information corresponding to a picture signals the presence of information of two fields. The value of the first of these two fields corresponds to the tier number associated with the second field of the two fields. The value of the first of the two fields signals the highest tier number that provides a “sufficient number of pictures” to provide for trick modes (i.e., playback speeds) of 2× and above. The second of the two fields provides the “sufficient number of pictures.”

HRD buffer management policies are irrelevant during PVR trick modes. There is no need to perform A/V synchronization. Pictures are decoded without having to wait for their DTS. PVR trick modes can be fulfilled while a decoder operates in a “special playback mode” under the control of a PVR application running in the receiver. (For MPEG-2 video, this special playback mode is Low-Delay.) MMCO usage is not constrained.

PVR assistance information may be signalled only at pictures where the tier of a picture is revealed. Discardable pictures may not need signalled. For instance, for an MPEG-2 GOP, the tier value of B pictures may not require to be signalled. Provided PVR assistance information corresponding to the RAP picture may include information pertaining to the “intended” or “approximate” minimum number of independently decodable pictures per second for “any” trick mode speed (i.e., 2× and above).

A single bit or flag provided with PVR assistance information corresponding to the RAP picture signals BLOCK trick mode for the “pictures presentation” span that starts with the “presentation” of the RAP picture up to, but not including, the presentation of the next RAP picture.

Below is a table that provides one example of a PVR assist information syntax. The semantics of the table is described below.

TABLE 1
PVR_information data field

| | No. of | |
|---|---|---|
| Syntax | Bits | Mnemonic |
| PVR_information ( ) { | | |
| data_field_tag | 8 | uimsbf |
| data_field_length | 8 | uimsbf |
| AU_PTS_present_flag | 1 | bslbf |
| RAP_present_flag | 1 | bslbf |
| next_pic_in_tier_present_flag | 1 | bslbf |
| Reserved | 2 | “00” |
| pic_tier_num_minus1 | 3 | bsblf |
| if (AU_PTS_present_flag == “1”) { | | |
| AU_PTS_32 | 32 | uimsbf |
| } | | |
| if RAP_present_flag == “1”) { | | |
| block_trick_mode | 1 | bslbf |
| min_num_decodable_pics | 5 | uismbf |
| top_tier_num_minus1 | 2 | uismbf |
| } | | |
| if (next_pic_in_tier_present_flag == “1”) | | |
| { | | |
| Reserved | 3 | “000” |
| num_pics_away | 5 | uismbf |
| } | | |
| for(i=0; i<n; i++) { | | |
| PVR_reserved_byte | 8 | bslbf |
| } | | |
| } | | |

Semantics are as follows:
data_field_tag: this shall have the value 0x03.
data_field_length: this indicates the length of the descriptor.
AU_PTS_present_flag: This field shall be set to “1” when the AU_PTS_{—}32 value is present in the descriptor, otherwise it shall take the value “0”.
RAP_present_flag: This field shall be set to “1” when the block_trick_mode value or min_num_decodable_pics value is present in the descriptor, otherwise it shall take the value “0”.
next_pic_in_tier_present_flag: This field shall be set to “1” when the num_pics_away value is present in the descriptor, otherwise it shall take the value “0”.
pic_tier_num_minus1: The tier number of the picture associated with this PVR assistive information equals this value+1. The top tier number is equal to “1” (i.e., value=“0”) and the bottom tier equals to “8” (value=“7”).
AU_PTS_{—}32: the 32 most significant bits of the 33-bit PTS encoded in the PES header immediately following this adaptation field, or of the value that applies to the access unit to which this descriptor applies, if no PES header is present.
block_trick_mode: this field is set to “1” when trick mode is to be disabled for the “picture presentation” span that starts with the “presentation” of the RAP picture up to, but not including, the presentation of the next RAP picture. Note that the block expires at the next RAP. If blocking is to be extended, then the block_trick_mode=1 must be reissued.
min_num_decodable_pics: this field conveys the value of the intended minimum number of independently decodable pictures per second for “any” trick mode speed (i.e., 2× and above) provided in tiers 1 to N, where N=(top_tier_num_minus1+1). The value of min_num_decodable_pics shall be less than or equal to half the number of decodable picture per second of the normal playback presentation of the AVC stream. top_tier_num_minus1: the value of this field+“1” equals the tier number associated with the value of min_num_decodable_pics.
Note: An encoder may use coupled parameters, min_num_decodable_pics and top_tier_num_minus1, to convey the minimum number of independently decodable pictures per second that it intends to provide in tiers 1 through N. A PVR application can retrieve and decode pictures in tiers 1 to N, starting from a RAP, to fulfill a PVR trick mode. For instance, the number of independently decodable pictures over a one second span in a 2× trick mode should be approximately twice the value of min_num_decodable_pics since at the end of 1.0 second, the picture presented should approximately correspond to a 2.0 second span of the normal playback of the video stream. A PVR application may opt to decode fewer pictures to fulfill a 2× trick mode presentation by only retrieving and decoding the pictures in tiers 1 to (N-1) or a lower tier number.
num_pics_away: the value of this field indicates the location of the next picture in the stream belonging to the same tier as the picture associated with this PVR assistive information.

It should be emphasized that the above-described embodiments of the present disclosure are merely possible non-limiting examples of implementations, merely setting forth a clear understanding of the principles of the disclosed systems and method embodiments. Many variations and modifications may be made to the above-described embodiments, and all such modifications and variations are intended to be included herein within the scope of the disclosure and protected by the following claims.

1. A method, comprising:
receiving an encoded video stream with a first picture, a first data field, and a second data field with a first value, wherein the first and second data fields correspond to the first picture, and where the first data field corresponds to a tier number corresponding to the first picture; and wherein the second data field corresponds to a flag that signals the blocking of a trick mode; and
associating the first value of the second data field to blocking of a trick mode; and associating the blocking of the trick mode to be effective until a subsequent picture in the video stream, said subsequent picture associated with a random access point of the video stream.

2. The method of claim 1, wherein the first picture in the video is associated with a random access point.

3. The method of claim 1, further comprising of receiving a third data field, wherein the third information corresponds to signaling the presence of information corresponding to the presentation of the picture.

4. The method of claim 1, further comprising of receiving a fourth data field, wherein the fourth information corresponds to signaling the presence of information corresponding to the location in the video stream of a subsequent picture having the same tier number as the first picture.

5. The method of claim 1, further comprising of receiving a fifth data field, wherein the fifth information corresponds to signaling the presence of information corresponding to the number of extractable pictures per second in the video stream for a trick mode.

6. The method of claim 1, wherein the number of extractable pictures correspond at least one tier number starting with the lowest tier number.

7. A method, comprising:
receiving a first information corresponding to a picture in a video stream, the first information including a tier number, wherein the first information is received outside of the payload portion of a transport packet, the transport packet comprising a first byte of a header of a packetized elementary stream (PES) containing the picture;
receiving the first picture;
receiving at least a portion of the video stream; and
providing portions of the at least received portion of the video stream in a trick mode.

8. The method of claim 7, wherein the video stream corresponds to an AVC compressed video stream.

9. The method of claim 7, wherein the provide portions of the AVC video stream in the trick mode corresponds to a sub-sequence of pictures that is not a compliant AVC video stream.

10. The method of claim 7, wherein the first information further includes a second data field corresponding to blocking of a trick mode.

11. A system, comprising:
a processor configured to provide plural data fields in a first portion of a transport packet contained in a video stream, the plural data fields further comprising:
a first information configured to signal a tier number corresponding to a picture, wherein the value of the tier number is according to a dependency of the picture on other pictures in the video stream; and
a second information configured to signal the presence of information corresponding to blocking of a trick mode.

12. The system of claim 11, wherein the first portion of the transport packet corresponds to a portion of the transport packet corresponding to an adaptation field.

13. The system of claim 12, wherein the transport packet corresponds to an MPEG-2 transport packet.

14. The system of claim 11, wherein the plural data fields further comprises a third information configured to signal an identification of a subsequent picture corresponding to a same tier number as the tier number of the picture.

15. The system of claim 11, wherein the second information corresponds to a one bit field.

16. The system of claim 11, wherein a first value of the second information signals the blocking of a trick mode, and wherein the picture corresponds to the picture associated with a random access point of the video stream.

17. The system of claim 16, wherein the first value of the second information signals the blocking of the trick mode to be effective until a subsequent picture in the video stream, said subsequent picture associated with a random access point of the video stream.

18. The system of claim 11, wherein the tier number corresponding to the picture is larger than or equal to all of the respective tier numbers corresponding to the pictures that the picture depends on.

19. The system of claim 11, wherein the tier number corresponding to the picture is larger than or equal to the tier number corresponding to a picture issuing a memory management control operation that affects picture referencing by the picture.

20. The system of claim 11, wherein the plural data fields further comprise of a third information configured to signal the presence of information corresponding to the presentation of the picture.
